(19) United States
(12) Patent Application Publication
(10) Pub. No.: US 2023/0261340 A1
(43) Pub. Date: Aug. 17, 2023

(54) PRISMATIC SECONDARY BATTERY INCLUDING STACK-TYPE CELL

(71) Applicant: LG ENERGY SOLUTION, LTD., Seoul (KR)

(72) Inventors: Young Jun KO, Daejeon (KR); Joo Hwan Sung, Daejeon (KR); Kyung Hwan Jung, Daejeon (KR)

(21) Appl. No.: 18/109,073

(22) Filed: Feb. 13, 2023

(30) Foreign Application Priority Data
Feb. 14, 2022 (KR) 10-2022-0018631

(51) Int. Cl. H01M 50/54; H01M 4/04; H01M 50/547; H01M 50/367

(52) U.S. Cl. CPC H01M 50/54; H01M 4/0404; H01M 50/547; H01M 50/367

(57) ABSTRACT

A battery includes an electrode assembly. The electrode assembly includes a first electrode including a first portion and a first tab extending from the first portion, a separator stacked on the first electrode, and a second electrode comprising a second portion and a second tab extending from the second portion stacked on the separator. The battery further includes a current collector assembly including a plate, a first current collector coupled to a proximal end of the plate including a first part and a second part opposite the first part, and a second current collector coupled to a distal end of the plate including a third part and a fourth part opposite the third part. The battery may further include a housing coupled to the plate. The first part and the second part of the first current collector may be configured to move in opposite directions.

### TECHNICAL FIELD

The present disclosure relates to a prismatic secondary battery, and more particularly, to a prismatic secondary battery including a stack-type cell and movable current collectors for slidably securing the electrodes of the prismatic secondary battery.

### BACKGROUND

Unlike primary batteries, secondary batteries are rechargeable, and because the size of secondary batteries can be made to be compact while exhibiting high capacity, a lot of research on secondary batteries is being conducted. The demand for secondary batteries as a source of energy is increasing due to the developments in battery technologies, increased demand for mobile devices, and the emergence of electric vehicles and energy storage systems, along with the increased awareness for the need for protecting the environment.

Secondary batteries can be classified as a coin type, a cylindrical type, a prismatic type, and a pouch type based on the shape of the battery case. In these secondary batteries, an electrode assembly mounted in a battery case is a rechargeable power generating device having a structure with electrodes and a separator that are stacked on top of each other.

Electrode assemblies may be classified as a jelly-roll type, a stack-type, and a stack/folding type. A jelly-roll type electrode assembly may include a separator that is interposed between a positive electrode and a negative electrode. In a jelly-roll type electrode assembly, each of the positive and negative electrodes may be a sheet coated with an active material. The positive electrode, the separator, and the negative electrode may then be wound into a roll.

A stack-type electrode assembly may include a plurality of positive and negative electrodes with separators interposed between the positive and negative electrodes that are stacked sequentially. A stack/folding type electrode assembly may include stack-type unit cells that are wound with a separation film.

Secondary batteries have fulfilled various demands in the market by combining the characteristics of the battery case shapes and the types of the electrode assemblies. In particular, in recent years, a new market has emerged for electric vehicles with a large number of secondary batteries that are mounted in the vehicles. Accordingly, for mass producing secondary batteries, productivity improvement through yield improvement and cost reduction has become a very important challenge to be solved. The present disclosure is directed to overcoming one or more of these challenges.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the present disclosure, a secondary battery, and more particularly, a prismatic secondary battery including a stack-type cell and movable current collectors for slidably securing the electrodes of the prismatic secondary battery may be provided to improve yield and reduce production costs of the secondary battery, while improving safety against swelling that may occurs during operation of the secondary battery.

Examples of the present disclosure relate to, among other things, batteries, current collector assembles, and methods of manufacturing batteries. Each of the examples disclosed herein may include one or more features described in connection with any of the other disclosed aspect.

In one example, a battery may be provided. The battery may include an electrode assembly. The electrode assembly may include: a first electrode comprising a first portion and a first tab extending from the first portion; a separator stacked on the first electrode; a second electrode comprising a second portion and a second tab extending from the second portion, the second electrode being stacked on the separator. The battery may further include a current collector assembly. The current collector assembly may include: a plate; a first current collector coupled to a proximal end of the plate, the first current collector including a first part and a second part opposite the first part; and a second current collector coupled to a distal end of the plate, the second current collector including a third part and a fourth part opposite the third part. The battery may further include a housing coupled to the plate. The first tab may be in a first accommodating space between the first part and the second part of the first current collector. The second tab may be in a second accommodating space between the third part and the fourth part of the second current collector. The first part and the second part of the first current collector may be configured to move in opposite directions.

In other aspects, the battery described herein may include one or more of the following features. The first portion of the first electrode may include an active material. The first accommodating space may be an opening between a proximal end of the first part and a distal end of the first part. The second accommodating space may be an opening between a proximal end of the third part and a distal end of the third part. The first tab may be bent toward the first part or the second part. A portion the first tab may be coupled to a surface of the first current collector. The battery may further include a friction reducing element between the first tab and the first part or the second part. The first part and the second part may apply pressure to the first tab. The plate may include a venting portion. The plate may include a terminal electrically coupled to the first tab or the second tab. A side of the electrode assembly may be spaced apart from the first current collector or the second current collector. An end of the first tab may be coupled to a coupling portion on a surface of the first part or the second part of the current collector. The first tab may form an arc between the coupling portion and the first accommodating space. The first tab may be configured to slide between the first accommodating space. The housing may include a terminal electrically coupled to the first tab or the second tab. The housing may include a venting portion.

In another example, a current collector assembly for a battery may be provided. The current collector assembly may include: a plate; a first current collector coupled to a proximal end of the plate, the first current collector comprising a first part and a second part opposite the first part; a second current collector coupled to a distal end of the plate, the second current collector including a third part and a fourth part opposite the third part; a first accommodating space between the first part and the second part of the first current collector; and a second accommodating space between the third part and the fourth part of the second current collector. The first part and the second part of the first current collector may be configured to move in opposite directions.

In other aspects, the current collector assembly described herein may include one or more of the following features. The plate may include a venting portion.

In yet another example, a method of manufacturing a battery may be provided. The method may include the steps of: forming a stack-type electrode assembly by: providing a first electrode comprising a first portion and a first tab extending from the first portion; stacking a separator on the first electrode; and stacking a second electrode on the separator, the second electrode comprising a second portion and a second tab extending from the second portion; and forming a current collector assembly by: providing a plate; coupling a first current collector to a proximal end of the plate, the first current collector comprising a first part and a second part opposite the first part; and coupling a second current collector to a distal end of the plate, the second current collector including a third part and a fourth part opposite the third part; separating the first part and the second part of the first current collector in opposite directions; inserting the first tab into a first accommodating space between the first part and the second part of the first current collector; and inserting the second tab into a second accommodating space between the third part and the fourth part of the second current collector.

In other aspects, the method of manufacturing the battery described herein may include one or more of the following features. The method may further include bending the first tab in a first direction toward the first part or the second part. The method may further including attaching an end of the first tab to a surface of the first part or the second part.

It is to be understood that both the foregoing general description and the following detailed description are exemplary and explanatory and are not restrictive of the disclosed embodiments, as claimed.

### BRIEF DESCRIPTION OF THE DRAWINGS

The accompanying drawings illustrate exemplary embodiments of the present disclosure and, together with the following detailed description, serve to provide further understanding of the technical spirit of the present disclosure. However, the present disclosure is not to be construed as being limited to the drawings.

FIG. 1 is an exploded perspective view of an exemplary stack-type battery, according to aspects of the present disclosure.

FIG. 2A is a cross-sectional view of an exemplary stack-type electrode assembly, according to aspects of the present disclosure.

FIG. 2B is a top down view of an exemplary cathode and anode, according to aspects of the present disclosure.

FIG. 3 is an exploded perspective view of an exemplary battery cell, according to aspects of the present disclosure.

FIG. 4A is a perspective view of an exemplary current collector assembly, according to aspects of the present disclosure.

FIG. 4B is a perspective view of another exemplary current collector assembly, according to aspects of the present disclosure.

FIG. 5 is a perspective view of an exemplary assembled battery cell, according to aspects of the present disclosure.

FIG. 6A is a partial perspective view an exemplary battery cell, according to aspects of the present disclosure.

FIG. 6B is a partial perspective view another exemplary battery cell including a welling portion, according to aspects of the present disclosure.

FIG. 7A is a partial perspective view an exemplary battery cell with a folded electrode tab, according to aspects of the present disclosure.

FIG. 7B is a partial perspective view another exemplary battery cell with a folded electrode tab including a welling portion, according to aspects of the present disclosure.

FIG. 8 is a partial perspective view of an exemplary battery cell including a plurality of stack-type electrode assemblies, according to aspects of the present disclosure.

FIG. 9 is a cross-sectional view of an exemplary battery cell including a spare length portion, according to aspects of the present disclosure.

FIG. 10 is a cross-sectional view of the exemplary battery cell of FIG. 9 after a swelling has occurred, according to aspects of the present disclosure.

FIG. 11 is a cross-sectional view of an exemplary battery cell including a plurality of stack-type electrode assembly with spare length portions, according to aspects of the present disclosure.

FIG. 12 is a cross-sectional view of an exemplary battery cell including a plurality of stack-type electrode assembly with spare length portions and a single welding portion, according to aspects of the present disclosure.

FIG. 13 is a cross-sectional view of an exemplary battery cell including a friction reduction structure, according to aspects of the present disclosure.

FIG. 14 is a cross-sectional view of an exemplary battery cell including another friction reduction structure, according to aspects of the present disclosure.

### DETAILED DESCRIPTION

The present disclosure is directed to providing an effective method for improving yield and reducing production costs of secondary batteries, in particular, prismatic secondary batteries. The present disclosure is also directed to securing safety against swelling that occurs during use of a secondary battery.

However, the technical objects to be solved by the present disclosure are not limited to the above-described objects, and other objects that are not described herein will be clearly understood by those skilled in the art from the following descriptions of the present disclosure.

A stack-type electrode structure of the present disclosure may include a stack-type electrode assembly in which unit cells including a positive electrode and a negative electrode with a separator interposed therebetween may be stacked vertically, and each of a positive electrode uncoated portion and a negative electrode uncoated portion of each unit cell may be disposed on one of facing side surfaces, and a current collector plate including a positive electrode terminal and a negative electrode terminal. The current collector plate may include a positive electrode current collector and a negative electrode current collector which may be each made of a conductive material, may be electrically connected to the positive electrode terminal and the negative electrode terminal, respectively, and may extend vertically from both ends thereof, and the positive electrode current collector and the negative electrode current collector may be coupled to the positive electrode uncoated portion and the negative electrode uncoated portion, respectively.

The positive electrode uncoated portion and the negative electrode uncoated portion may serve as a positive electrode tab and a negative electrode tab, respectively, and widths of the positive electrode uncoated portion and the negative electrode uncoated portion may correspond to widths of a positive electrode coated portion and a negative electrode coated portion, respectively.

The positive electrode current collector or the negative electrode current collector may be a clip structure configured to elastically fix the positive electrode uncoated portion or the negative electrode uncoated portion, respectively.

At least one of the positive electrode uncoated portion and the negative electrode uncoated portion may be welded in a state of being fixed to the clip structure.

In the positive electrode uncoated portion or the negative electrode uncoated portion, stacked uncoated portions may be welded to each other.

In the positive electrode uncoated portion or the negative electrode uncoated portion, stacked uncoated portions may be welded to the clip structure.

The positive electrode uncoated portion or the negative electrode uncoated portion may further include a structure of which a protruding end portion is bent toward the clip structure.

A plurality of positive electrode current collectors, each of which is identical to the positive electrode current collector, or a plurality of negative electrode current collectors, each of which is identical to the negative electrode current collector, may be disposed in parallel with respect to the current collector plate, and the positive electrode uncoated portion or the negative electrode uncoated portion may be divided into the number of uncoated portions corresponding to the number of positive electrode current collectors or negative electrode current collectors, and the uncoated portions may be individually fixed to the positive electrode current collectors or the negative electrode current collectors.

The positive electrode current collector and the negative electrode current collector may be the clip structure configured to elastically fix the positive electrode uncoated portion and the negative electrode uncoated portion, respectively, and each of the positive electrode uncoated portion and the negative electrode uncoated portion may include a spare length portion corresponding to swelling of the stack-type electrode assembly.

The spare length portion may be formed subsequent to a ligation portion of the clip structure to which the positive electrode uncoated portion and the negative electrode uncoated portion are fixed.

An end portion of the spare length portion may form a welding portion bonded to the clip structure.

The spare length portion may form a U-turn portion between the ligation portion and the welding portion.

When the stack-type electrode assembly is provided as a plurality of stack-type electrode assemblies, the positive electrode uncoated portion and the negative electrode uncoated portion extending from each of the plurality of stack-type electrode assemblies may form ligation portions that are independent of each other with respect to the clip structure.

The clip structure may be provided as a plurality of clip structures corresponding to the number of stack-type electrode assemblies, each stack-type electrode assembly may be supported by the ligation portion of a corresponding clip structure, and an end portion of the spare length portion provided in each of the positive electrode uncoated portion and the negative electrode uncoated portion extending from each stack-type electrode assembly may form the welding portion with respect to the corresponding clip structure.

The clip structure may include the plurality of ligation portions corresponding to the number of stack-type electrode assemblies, and each stack-type electrode assembly may be supported by a corresponding ligation portion.

End portions of the spare length portions provided in the positive electrode uncoated portion and the negative electrode uncoated portion extending from each stack-type electrode assembly may form one welding portion.

The clip structure may include a friction reducing structure on a contact surface of the ligation portion configured to support the positive electrode uncoated portion and the negative electrode uncoated portion of the stack-type electrode assembly.

The friction reducing structure may be an embossing structure formed on the contact surface of the ligation portion.

The friction reducing structure may be a low friction coating layer formed on the contact surface of the ligation portion.

Examples of the present disclosure may be used to provide a stack-type battery. In some embodiments, a notching (punching) process for an uncoated portion can be omitted in manufacturing the stack-type electrode assembly, thereby reducing yield reduction and process management difficulties due to the notching process.

Further, in a stack-type battery of the present disclosure, since positive and negative electrode uncoated portions serving as electrode tabs include spare length portions, even when swelling occurs in the stack-type electrode assembly due to battery degradation or impact caused by repeated charging and discharging, excessive stress is not applied to a welding portion, thereby improving safety by preventing the disconnection of the electrode tab during use of a secondary battery.

In addition, in the present disclosure, a portion of an electrode tab is secured using a clip structure, and the movement of the electrode tab due to swelling is induced by facilitating a sliding motion, so that the electrode tab is moved in proportion to an amount of swelling of a stack-type electrode assembly. Accordingly, a spare length portion of the electrode tab can effectively respond to a swelling phenomenon of a stack-type electrode assembly, and the position and movement of the spare length portion can be precisely controlled to remove a risk of an internal short circuit or the like.

The technical effects obtainable through the present disclosure are not limited to the above-described effects, and other effects that are not described herein will be clearly understood by those skilled in the art from the following descriptions of the present disclosure.

While the present disclosure may be variously changed and have various embodiments, specific embodiments will be described in detail below.

However, it is to be understood that the present disclosure is not limited to the specific embodiments but includes all modifications, equivalents, and substitutions included in the spirit and the scope of the present disclosure.

In the present disclosure, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

Also, when a portion such as a layer, a film, an area, a plate, etc is referred to as being “on” another portion, this includes not only the case where the portion is “directly on” another portion but also the case where still another portion is interposed therebetween. On the other hand, when a portion such as a layer, a film, an area, a plate, etc. is referred to as being “under” another portion, this includes not only the case where the portion is “directly under” another portion but also the case where still another portion is interposed therebetween. In addition, to be disposed “on” in the present application may include the case disposed at the bottom as well as the top.

The present disclosure relates to a stack-type electrode structure. In one example, the stack-type electrode structure includes a stack-type electrode assembly in which unit cells including a positive electrode and a negative electrode with a separator interposed therebetween are stacked vertically, and each of a positive electrode uncoated portion and a negative electrode uncoated portion of each unit cell is disposed on one of facing side surfaces, and a current collector plate including a positive electrode terminal and a negative electrode terminal.

Here, the current collector plate includes a positive electrode current collector and a negative electrode current collector which are made of a conductive material, are electrically connected to the positive electrode terminal and the negative electrode terminal, respectively, and extend vertically from both ends thereof, and the positive electrode current collector and the negative electrode current collector are coupled to the positive electrode uncoated portion and the negative electrode uncoated portion, respectively.

In particular, according to the present disclosure, the positive electrode uncoated portion and the negative electrode uncoated portion serve as a positive electrode tab and a negative electrode tab, respectively, and widths of the positive electrode uncoated portion and the negative electrode uncoated portion correspond to widths of a positive electrode coated portion and a negative electrode coated portion, respectively.

As described above, in the stack-type electrode structure according to the present disclosure, a separate notching process is not performed on the positive electrode uncoated portion and the negative electrode uncoated portion serving as the positive electrode tab and the negative electrode tab. That is, the widths of the positive electrode uncoated portion and the negative electrode uncoated portion correspond to the widths of a positive electrode coated portion and a negative electrode coated portion, respectively, and a separate notching process of forming an electrode tab is omitted, thereby reducing yield reduction and process management difficulties due to the notching process and improving productivity.

Reference will now be made in detail to examples of the disclosure described above and illustrated in the accompanying drawings. Wherever possible, the same reference numbers will be used throughout the drawings to refer to the same or like parts.

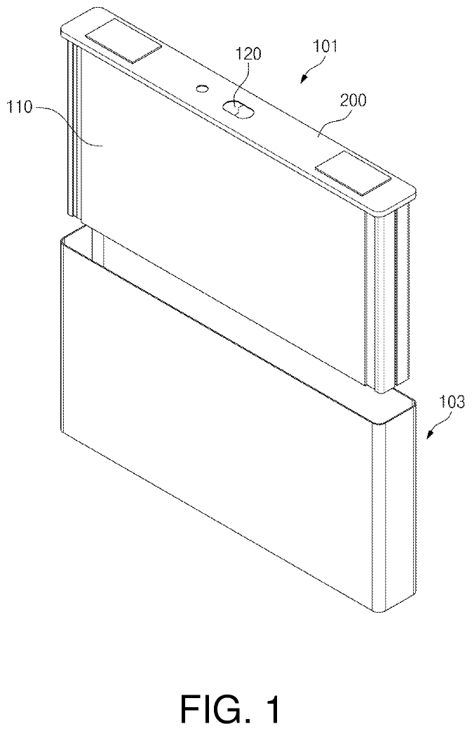

FIG. 1 is an exploded perspective view of a stack-type battery 100 according to an embodiment of the present disclosure. The stack-type battery 100 may include a battery cell 101 and a housing (or case) 103. In one embodiment, the battery cell 101 may include a stack-type electrode assembly 110 and a current collector assembly 200 coupled to the stack-type electrode assembly 110. In one embodiment, the battery cell 101 may be inserted through an opening of the housing 103 and disposed within the housing 103 to form the stack-type battery 100. For example, the battery housing 103 may be a hexahedral battery case which has an opening and space that is configured to accommodate the battery cell 101, but the shape and size of the battery housing is not limited thereto.

In one embodiment, the battery cell 101 may include a venting portion 120. The venting portion 120 may be configured to express any excess gas generated within the stack-type battery 100 before, during, and/or after operation of the stack-type battery 100. The venting portion 120 may be configured to change its shape when the pressure inside of the stack-type battery 100 is greater than a predetermined amount of pressure. For example, the venting portion 120 may made of a material that may deform and/or rip based on the predetermined amount of pressure inside of the stack-type battery. Accordingly, the excess gas generated within the stack-type battery 100 may be expressed to reduce the pressure inside of the stack-type battery 100. The predetermined amount of pressure may be based on the material of the housing 103 and/or pressure tolerances of the battery cell 101.

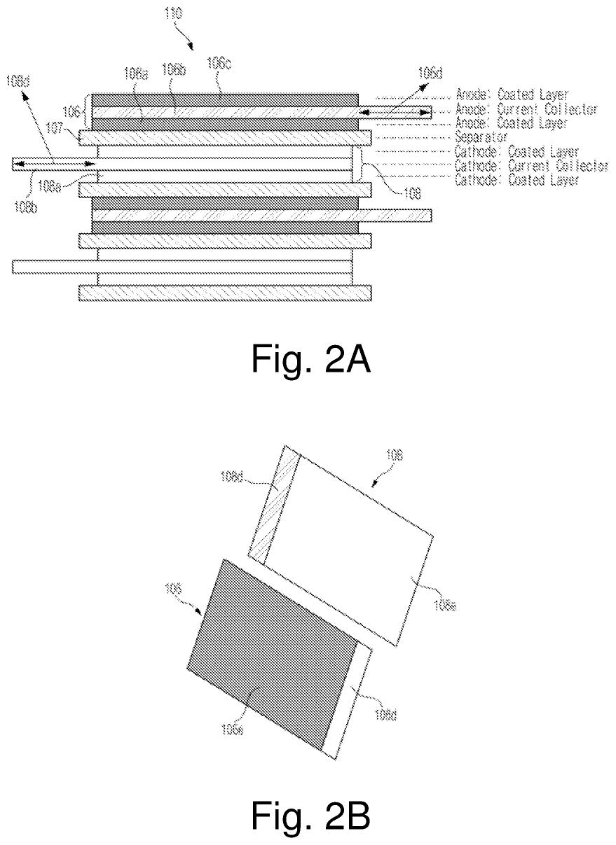

FIG. 2A illustrates a cross-sectional view of the stack-type electrode assembly 110 according to an embodiment of the present disclosure. In one embodiment, the stack-type electrode assembly 110 may include one or more anodes 106, one or more cathodes 108, and one or more separators 107 disposed between the one or more anodes 106 and the one or more cathodes 108, as shown in FIG. 2A. In one embodiment, the one or more anodes 106 may include a first anode layer 106a, a current collector 106b on top of the first anode layer 106a, and a second anode layer 106c on top of the current collector, as shown in FIG. 2A for example. In one embodiment, the first and second anode layers 106a, b may include an active material coated on one or more surfaces of the first and second anode layers 106a, b, and/or the current collector 106b of the anode 106. Further, the anode 106 may include an uncoated anode portion 106d. For example, the uncoated anode portion 106d may be at least a portion of the current collector 106b that does not include an active material, as shown in FIG. 2A for example. In the present disclosure, an uncoated portion may be defined as a portion where an active material is not coated on part or all of the uncoated portion.

In one embodiment, the one or more cathodes 108 may include a first coated cathode layer 108a, a current collector 108b on top of the first coated cathode layer, and a second coated cathode layer 108c on top of the current collector, as shown in FIG. 2A for example. In one embodiment, the first and second coated cathode layers 108a, b may include an active material coated on one or more surfaces of the first and second coated cathode layers 108a, b, and/or the current collector 108b of the cathode 108. Further, the cathode 108 may include an uncoated cathode portion 108d. For example, the uncoated cathode portion 108d may include at least a portion of the current collector 108b that does not include an active material, as shown in FIG. 2A for example. Uncoated, in this embodiment, may mean that an active material is not coated on part or all of the uncoated portion of the current collector 108b of the cathode 108.

In one embodiment, the stack-type electrode assembly 110 may be a bidirectional electrode assembly in which each of the uncoated anode portion 106d (e.g., positive electrode portion) and the uncoated cathode portion 108d (e.g., negative electrode portion) on opposite sides of the stack-type battery 100.

FIG. 2B illustrates a top-down view showing an exemplary anode 106 and an exemplary cathode 108, according to one embodiment of the present disclosure. FIG. 2B illustrates the anode 106 including the uncoated anode portion 106d and a coated anode portion 106e. Further, FIG. 2B illustrates a cathode 108 including the uncoated cathode portion 108d and a coated cathode portion 108e. In one embodiment, the uncoated cathode and anode portions 106d, 108d may be disposed along one side of the anode 106 and the cathode 108, respectively, as shown in FIG. 2B. Unlike anodes and cathodes of conventional electrode assemblies, the anode 106 and the cathode 108 may not include notching(s) along the side where the uncoated portions 106d, 109d are provided. That is, in this embodiment, the anode 106 may include the uncoated anode portion 106d that is disposed along the full length of the anode 106, as shown in FIG. 2B. Also, the cathode 108 may include the uncoated cathode portion 180d that is disposed along the full length of the anode 106, as shown in FIG. 2B. Accordingly, manufacturing the stack-type battery 100 with the anode 106 and the cathode 108 having uncoated portions without any notching will yield improved production efficiency.

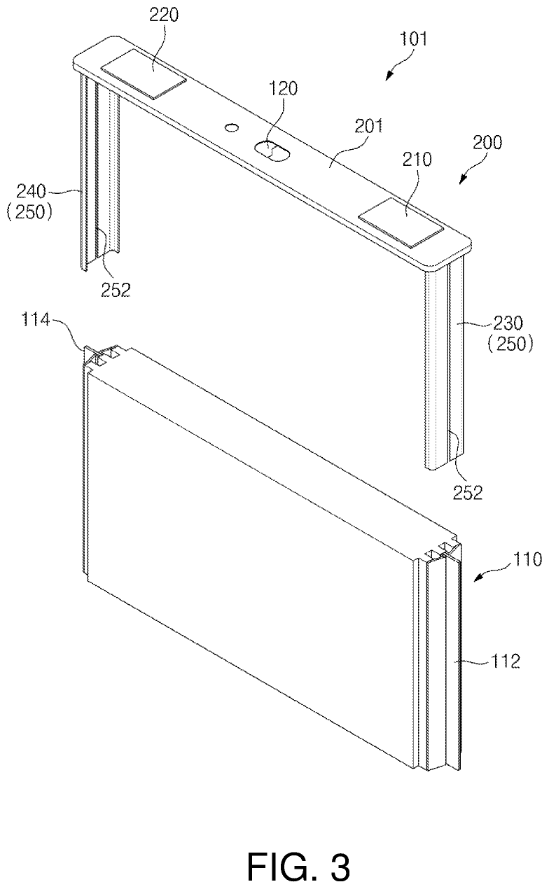

FIG. 3 is an exploded view of the battery cell 101 according to an embodiment of the present disclosure. In one embodiment, the battery cell 101 may include a stack-type electrode assembly 110 and a current collector assembly 200. The battery cell 101 may be a structure formed by combining the stack-type electrode assembly 110 and the current collector assembly 200, as shown in FIG. 1 for example.

In one embodiment, the current collector assembly 200 may include a plate 201, a positive electrode terminal 210 and a negative electrode terminal 220. The positive electrode terminal 210 and the negative electrode terminal 220 may be disposed on the plate 201 and may have a rectangular shape, but are not limited thereto. Further, the current collector assembly 200 may include a positive electrode current collector 230 and a negative electrode current collector 240 which may each be made of a conductive material. The positive electrode current collector 230 and the negative electrode current collector 240 may be collectively referred as a clip structure(s) 250. A proximal end of the positive current collector 230 may be connected to an end of the plate 201, and a proximal end of the negative current collector 240 may be connected to the opposite end of the plate 201, as shown in FIG. 3. The positive electrode current collector 230 and the negative electrode current collector 240 may be electrically connected to the positive electrode terminal 210 and the negative electrode terminal 220, respectively. As shown in FIG. 3, the positive and negative current collectors 230, 240 may extend vertically from opposite ends of the plate 201 thereof. Accordingly, the current collector assembly 200 may be a plate-shaped member including current collectors that may be inserted through and coupled to any opening of a housing (or battery case) 103 (not shown in this figure for clarity of illustration) to form a seal. For example, the current collector assembly 200 may be coupled to a battery case (e.g., hexahedral battery case or housing 103) which has an opening formed at an upper portion thereof to accommodate the battery cell 101. The current collector assembly 200 may be referred to as a cap plate because the plate 201 of the current collector assembly 200 may be positioned on an upper surface the stack-type battery 100 to function as a cap for covering the opening of the housing 103.

Still referring to FIG. 3, the stack-type electrode assembly 110 may include an uncoated positive electrode tab 112 and an uncoated negative electrode tab 114. The uncoated positive electrode tab 112 may include a plurality of uncoated anode portions (e.g., uncoated anode portion 106d) of an anode current collectors (e.g., anode current collector 106b). The shape and size of the uncoated positive and negative electrode tabs 112, 114 may correspond to the shape of the uncoated anode portion 106d and the uncoated cathode portion 108d, respectively, but are not limited thereto. Further, the uncoated negative electrode tab 114 may include a plurality of uncoated cathode portion (e.g., uncoated cathode portion 180d) of the cathode current collectors (e.g., cathode current collector 108b). In one embodiment, the positive electrode current collector 230 and the negative electrode current collector 240 may be coupled to the uncoated positive electrode tab 112 and the uncoated negative electrode tab 114 of the stack-type electrode assembly 110 to constitute the battery cell 101 according to embodiments of the present disclosure.

Still referring to FIG. 3, the positive and negative electrode current collectors 230, 240 may be made of conductive materials. However, it should be noted that the fact that the positive electrode current collector 230 and the negative electrode current collector 240 are each made of a conductive material does not mean that the entireties of the current collectors 230 and 240 are limited to being made of the conductive material. For example, in some embodiments, only portions of the current collectors 230 and 240 coupled to or come in contact with the uncoated tabs 112 and 114 may be made of conductive materials.

In embodiments of the present disclosure, the positive electrode uncoated tab 112 and the negative electrode uncoated tab 114 may be a positive electrode tab and a negative electrode tab, respectively. Further, the width of the uncoated positive electrode tab 112 and the width of the uncoated negative electrode tab 114 may correspond to the width of a coated portion of the anode 106 and a coated portion of the cathode 108, respectively, as shown in FIG. 2B for example. The widths of the uncoated tabs 112 and 114 corresponding to the widths of the coated portions of the anode 106 and the cathode 108 may allow omission of a separate notching process for forming electrode tabs. Accordingly, in the present disclosure, the productivity of a secondary battery is improved by fundamentally eliminating yield reduction and process management difficulties required in the convention notching process.

Still referring to FIG. 3, the positive electrode current collector 230 and the negative electrode current collector 240 may be referred, hereinafter, collectively as clip structure(s) 250 which may elastically or movably fix the uncoated positive electrode tab 112 and the uncoated negative electrode tab 114, respectively. In the present disclosure, the clip structure(s) 250 may be defined to be a term for any structure that is similar to a type of tongs or other mechanisms that may apply sufficient pressure to the uncoated tabs 112 and 114 to affix or secure the uncoated tabs 112 and 114 to the positive and negative electrode current collectors 230, 240.

Due to the characteristics of the clip structures 250 of the current collectors 230, 240, the coupling or securing of the uncoated tabs 112 and 114 to the current collectors 230 and 240 may be made firmly and easily. In one embodiment, the clip structure 250 is illustrated as having a slit(s) (or openings) 252 or a through-groove(s) formed in a vertical direction of the positive electrode current collector 230 and/or the negative electrode current collector 240. The size and shape of the slit (or opening) 252 is not limited thereto. The uncoated tabs 112 and 114 may be inserted or slid into and firmly coupled or secured to the slits (or openings) 252 of the current collectors 230 and 240.

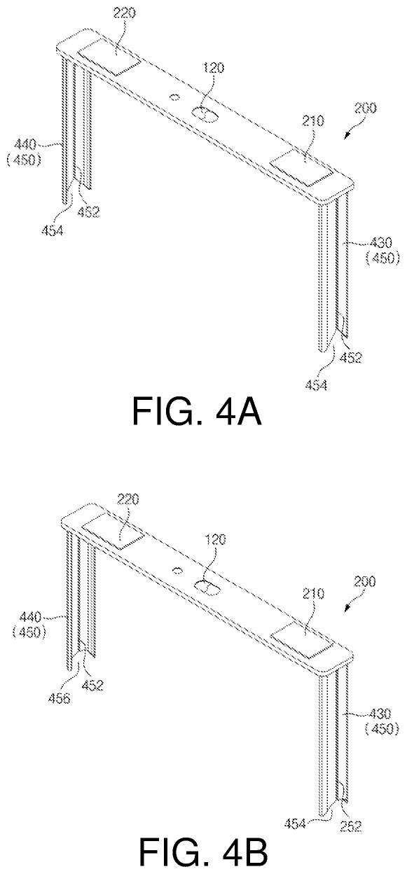

FIGS. 4A and 4B illustrate perspective views of the current collector assembly 200 in accordance with alternative embodiments of the present disclosure. FIG. 4A illustrates a current collector assembly 200 that may include a positive electrode current collector 430 and a negative electrode current collector 440 which may each be made of a conductive material. The positive electrode current collector 430 and the negative electrode current collector 40 may be collectively referred as a clip structure(s) 450. The positive electrode current collector 430 and the negative electrode current collector 440 may be electrically connected to the positive electrode terminal 210 and the negative electrode terminal 220, respectively. In this embodiment, the positive electrode current collector 430 may include a notch 454 at a distal end thereof. Similarly, the negative electrode current collector 440 may include a notch 454 at a distal end thereof. The notch(s) 454 may be configured to facilitate insertion or sliding of the uncoated negative and/or positive electrode tabs 112 into the slit(s) (or openings) 452 of the positive and/or negative electrode current collectors 430, 440. Due to the shape and size of the notch(s) 454, the uncoated positive electrode tab 112 may easily be inserted or slid into the slit (or opening) 452. Accordingly, the notch 452 may allow greater manufacturing tolerances and improve manufacturing yield and efficiencies.

FIG. 4B illustrates an alternative embodiment for the current collector assembly 200. In this embodiment, the positive electrode current collector 430 may include a semi-circular cutout 456 at a distal end thereof. Similarly, the negative electrode current collector 440 may include semi-circular cutout 456 at a distal end thereof. The semi-circular cutout(s) 456 may be configured to facilitate insertion or sliding of the uncoated negative and/or positive electrode tabs 112 into the semi-circular cutout(s) 456 of the positive and/or negative electrode current collectors 430, 440. Due to the shape and size of the semi-circular cutout(s) 454, the uncoated positive electrode portion 112 may easily be inserted or slid into the semi-circular cutout(s) 454. Accordingly, the semi-circular cutout(s) 454 may allow greater manufacturing tolerances improve manufacturing yield and efficiencies.

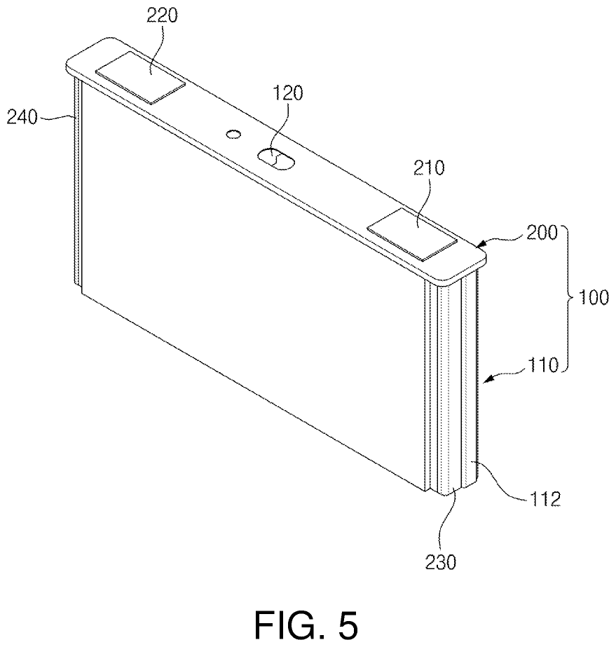

FIG. 5 illustrates a perspective view of an assembled battery cell 101 according to an embodiment of the present disclosure. As shown in FIG. 5, the assembled battery cell 101 may include the stack-type electrode assembly 110 that is coupled to the current collector assembly 200 by sliding or inserting the uncoated positive electrode tab 112 and the uncoated positive electrode tab 114 (not shown in this figure for clarity of illustration) into the slits (or openings) 252 of the positive and negative electrode current collectors 230, 240. In this embodiment, the uncoated positive electrode tab 112 may be folded toward one side of the positive electrode current collector 230 to couple to at least a portion of a surface of the uncoated positive electrode portion 112 to at least a portion of a surface of the positive electrode current collector 230, as shown in FIG. 5 for example. Although not shown in FIG. 5 for clarity of illustration, the uncoated negative electrode tab 114 may be folded to one side of the negative electrode current collector 240 in a similar manner Coupling a surface of the uncoated positive or negative electrode tabs 112, 114 may facilitate greater electrical contact between the uncoated electrode tabs 112, 114 and the electrode current collectors 230, 240, as well as increasing the coupling strength between the uncoated electrode tabs 112, 114 and the electrode current collectors 230, 240.

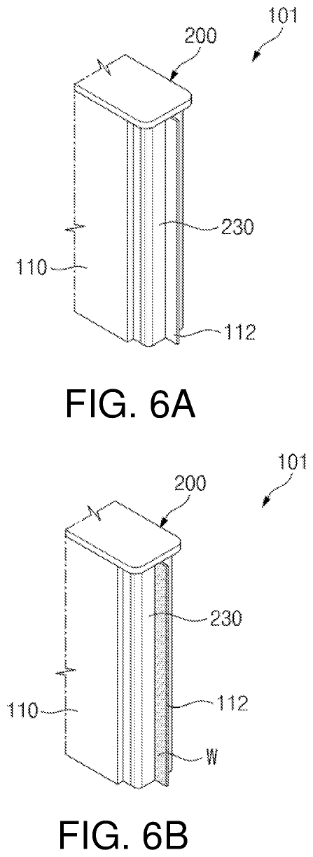

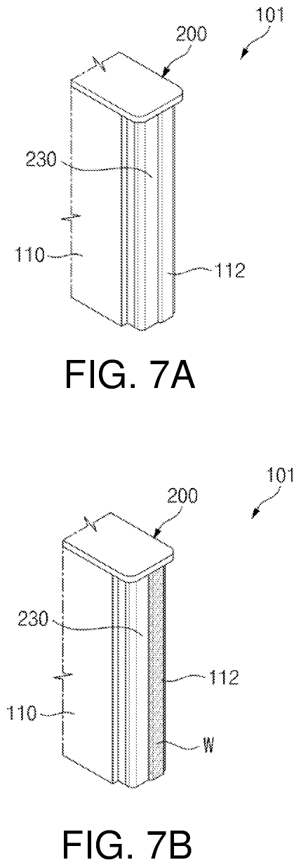

FIGS. 6A-7B illustrate various coupling arrangements or configurations of the uncoated tabs 112 and 114 and the electrode current collectors 230 and 240, in accordance with the present disclosure. For example, FIGS. 6A-7B illustrate a coupling arrangement or configuration of the uncoated positive electrode tab 112 and the positive electrode current collector 230. The coupling arrangement or configuration may be equally applied to the uncoated negative electrode tab 114 and the negative electrode current collector 240 at an opposite side thereof. Only one side of the assembled battery cell 101 is illustrated in these embodiments for clarity of illustration and explanation.

FIG. 6A illustrates an embodiment where the uncoated positive electrode tab 112 may be in fixed or secured to the positive electrode current collector 230 by being inserted or slid into the slit (or opening) 252 of the positive electrode current collector 230. In this embodiment, no additional processing may be required. Accordingly, the coupling structure in this embodiment may provide a relatively simple coupling structure.

Alternatively, as shown in FIG. 6B, the uncoated positive electrode tab 112 may be fixed or secured to the positive electrode current collector 230 by being inserted or slid into the slit (or opening) 252 of the positive electrode current collector 230 and welded at or near a welding area W shown in FIG. 6B. By welding, the coupling strength between the uncoated positive electrode tab 112 and the positive current collector 230 will increase and improve reliability of the coupling. In this embodiment, the uncoated positive electrode tab 112 may be formed by welding together a plurality of uncoated anode portions (e.g., 106d) that may be stacked on top of each other. Additionally, the stacked uncoated anode portions (e.g., 106d) of the uncoated positive electrode tab 112 may be welded together to the positive electrode current collector 230 at or near the welding area W. Although the welding area W is illustrated in FIG. 6B as being formed on the entire uncoated positive electrode tab 112, this is merely an example, and of course, the welding area W may be formed only on a portion thereof.

FIG. 7A illustrates the uncoated positive electrode tab 112 or the uncoated negative electrode tab 114 with a protruding end or edge portion that may be bent toward one side of the clip structure(s) 250 or current collectors 230, 240 according to an embodiment of the present disclosure. The protruding end portions of the uncoated tabs 112 and 114 may be bent toward one side of the clip structure(s) 250 or current collectors 230, 240 to further increase the coupling strength between the uncoated electrode tabs 112, 114 and the electrode current collectors 230, 240 and to reduce any unnecessary volume or space in the stack-type battery 100. Accordingly, the capacity of the stack-type battery 100 is increased compared to other prismatic secondary batteries having the same or similar size.

FIG. 7B illustrates the uncoated positive electrode tab 112 or the uncoated negative electrode tab 114 with a protruding end or edge portion that may be bent toward the clip structure(s) 250 similar to the embodiment described in reference to FIG. 7A above. Additionally, the uncoated positive electrode tab 112 or the uncoated negative electrode tab 114 may be welded to the current collectors 230, 240 at or near the welding area W to further increase the coupling strength between the uncoated electrode tabs 112, 114 and the electrode current collectors 230, 240 and to reduce any unnecessary volume or space in the stack-type battery 100. Accordingly, the capacity of the stack-type battery 100 is increased compared to other prismatic secondary batteries having the same or similar size.

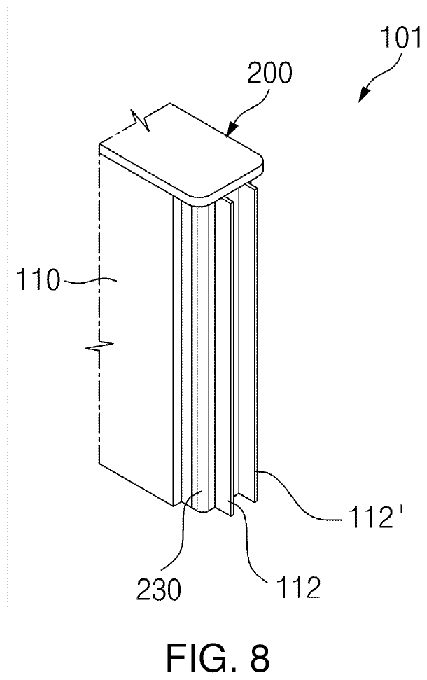

FIG. 8 illustrates a perspective view of a battery cell 101 according to an embodiment of the present disclosure. In this embodiment, the battery cell 101 may include a plurality of uncoated positive electrode tabs 112, 112′ arranged parallel to each other, as shown in FIG. 8. In this embodiment, the positive electrode current collectors 230 or the negative electrode current collectors 240 may include a plurality of portions that are arranged in parallel to each other and disposed vertically with respect to a current collector assembly 200 to form plurality of slits (or openings) 252 (not shown in the figure for clarity of illustration). Accordingly, the uncoated positive electrode tab 112 or the uncoated negative electrode tab 114 may be divided into a plurality of uncoated tabs, 112, 112′, 114, 114′ corresponding to the number of the plurality of portions of the positive electrode current collectors 230 or negative electrode current collectors 240, and the uncoated tabs 112, 112′, 114, 114′ may be individually fixed or secured to the positive electrode current collectors 230 or the negative electrode current collectors 240 via the slits (or openings) 252 in accordance with the foregoing embodiments of the present disclosure. Although two positive electrode uncoated tabs 112 and 112′ are illustrated in FIG. 8, a similar arrangement or configuration may be applied to the uncoated negative electrode tabs 114, 114′ according to the foregoing embodiments of the present disclosure. Since a plurality slits (or openings) 252 and a plurality of portions of the current collectors 230 and 240 may be provided, a stable coupling strength between the uncoated tabs 112, 114 and the current collectors 230, 240 may be provided even when the thickness of the stack-type electrode assembly 110 is increased. Accordingly, the secondary battery of the present disclosure is scalable for providing manufacturing flexibility even when the size of the secondary battery is increased. In this embodiment, the fact that the plurality of portions of the current collectors 230 and 240 are provided does not necessarily mean that there are a plurality of structurally independent current collectors 230 and 240. For example, as shown in FIG. 8, a plurality of clip structures 250 or current collectors 203, 240 may be structurally formed by forming a plurality of slits (or openings) 252 (not shown in the figure for clarity of illustration and explanation) in one current collector 230 or 240, as discussed above.

Additionally or alternatively, although not shown, the bending structure (or configuration) or the welding area W described in the foregoing embodiments may be applied to each of the uncoated tabs 112 and 114 described in various embodiments of the present disclosure.

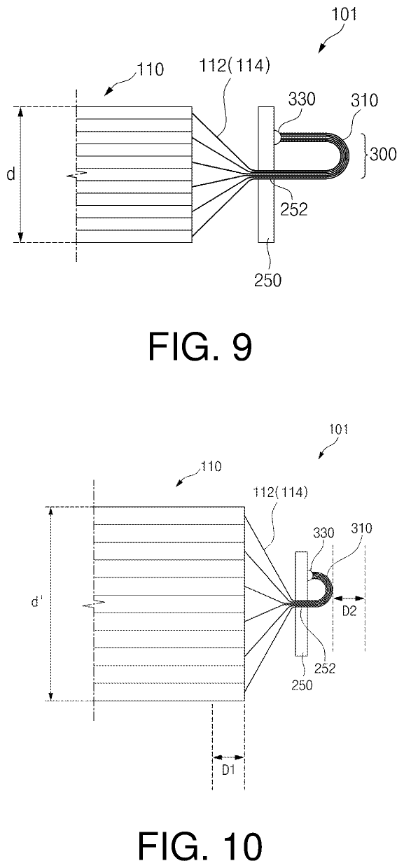

FIG. 9 is a cross-sectional view illustrating a coupling arrangement or configuration of the uncoated positive and/or negative electrode tabs 112 and 114, which serve as the electrode tabs of a stack-type electrode assembly 110, and clip structures 250 or current collectors 230, 240. As shown in FIG. 9, the uncoated positive electrode tab 112 or the uncoated negative electrode tab 114 may extend away from the stack-type electrode assembly 110 and through the slit (or opening) 252. The uncoated positive electrode tab 112 or the uncoated negative electrode tab 114 may include a spare length portion 300, for example in an arc or curved shape, which may change its length based an amount of swelling caused by the stack-type electrode assembly 110.

A swelling phenomenon is a phenomenon that may occur in the stack-type electrode assembly 110. For example, the stack-type electrode assembly 110 may gradually swell over time due to repeated charging and discharging of the stack-type electrode assembly 110. Also, the swelling phenomenon may be caused by a lithium ion electrolyte in a conventional battery that may vaporize during operation. The battery may swell or the shape of a surface(s) of the battery may become deformed, for example in a convex shape, due to the pressure generated within the battery when the electrolyte vaporizes. In addition to the swelling phenomenon causing deformation of a battery case or housing, in severe cases, when an electrolyte leaks from the conventional battery, fire or explosion may occur.

The swelling phenomenon may also affect the internal structure of a secondary battery. For example, the swelling in a battery may cause physical stress to be applied to an electrode tab. In a conventional stack-type electrode assembly, electrode tabs (positive electrode tab and negative electrode tab) of each of a plurality of stacked unit cells may be coupled to electrode terminals (positive electrode terminal and negative electrode terminal) by welding. Accordingly, the distance from a unit cell to the electrode terminal may vary based on the thickness of the stack-type electrode assembly. As such, when the swelling phenomenon occurs in the stack-type electrode assembly, a relative position of the unit cell from the electrode terminal may be depend on the distance from a battery cell to an electrode terminal. Accordingly, a stronger tensile force is applied to an electrode tab of the battery cell that is far away from the electrode terminal when swelling occurs in the battery cell. However, when welding parts of an electrode tab and an electrode terminal are designed, only a minimal spare portion is provided for manufacturing deviation. Therefore, when a battery is degraded and swelling occurs, an electrode tab, to which a strong tensile force is applied, is easily short-circuited at an electrode terminal attached thereto, and the disconnection of the electrode tab adversely affects the safety of the battery.

Still referring to FIG. 9, to prevent disconnection or short-circuiting of the uncoated positive electrode tab 112 and the uncoated negative electrode tab 114 from a welding point 330 due to the swelling phenomenon, the uncoated positive electrode tab 112 and the uncoated negative electrode tab 114 of a battery cell 101 may include a spare length portion 300. The length of the spare length portion 300 may be based on the amount of swelling that may occur in the battery cell 101. When the relative position of the stack-type electrode assembly 110 from the uncoated positive and negative electrode tabs 112, 114, which are electrically connected to the electrode terminals 210 and 220, is changed due to the swelling phenomenon, the length of the spare length portion 300 may change in response to the change in the relative position. Thus, the stress being applied to the uncoated positive and negative electrode portions 112, 114 due to the swelling phenomenon may be greatly reduced or eliminated even when the relative position of the stack-type electrode assembly 110 changes significantly.

FIG. 10 illustrates an electrode tab 112 or 114 of a battery cell 101 extending from the stack-type electrode assembly 110 that may be supported by the clip structure 250 at a slit (or opening) 252 thereof. The electrode tabs 112, 114 may be electrically connected to the electrode terminals 210, 220, and the spare length portion 300, for example in an arc or curved shape, may be formed after being inserted through the slit (or opening) 252 of the clip structure 250. An end portion of the spare length portion 300 forms a welding portion 330 bonded to the clip structure 250, and through the welding portion, the electrode tab 112 or 114 is electrically connected to the electrode terminal 210 or 220 through the clip structure 250.

In one embodiment, the clip structure 250 of the present disclosure may be a component that may physically hold and support the electrode tabs 112 and 114, which may be comprise bundles or a plurality of uncoated anode or cathode portions 106d, 108d, via the slit (or opening) 252 irrespective of the shape thereof. For example, as shown in the FIG. 10, the uncoated positive or negative electrode tab 112 or 114 may be inserted into a slit (or opening) 252 formed in the clip structure 250 to be temporarily fixed. In this case, the temporary fixing refers to a fixed state in which a position of the uncoated positive or negative electrode tab 112 or 114 that inserted into the clip structure 250 is usually fixed, but relative motion may occur when a certain degree of tensile force is applied.

The slit (or opening) 252 of the clip structure 250 is a portion that may press the electrode tab 112 or 114 to temporarily fix the electrode tab 112 or 114, and the spare length portion 300 formed subsequent to the slit (or opening) of the clip structure 250 may be configured to respond to the swelling of the stack-type electrode assembly 110. That is, when the stack-type electrode assembly 110 swells and a tensile force is applied to the electrode tab 112 or 114, the spare length portion 300 in the slit (or opening) 225 moves toward the stack-type electrode assembly 110, thereby greatly relieving stress acting on the electrode tab 112 or 114. In embodiments, the polarities of the electrode tabs 112 and 114 and the positive and negative electrode terminals 210 and 220 are not specifically distinguished may be referred interchangeably, and this is because configurations of the spare length portion 300 of the electrode tab 112 or 114 and the clip structure 250 may be applied without distinction between a positive electrode and a negative electrode.

In one embodiment, the spare length portion 300 may form a U-turn (or a curved) portion 310 between the slit (or opening) 252 and the welding portion 330. The U-turn portion 310 may form a gentle curve toward the slit (or opening) 252 of the clip structure 250 to reduce resistance that hinders the movement of the spare length portion 300. In one embodiment, the relative position of a top of the U-turn portion 310 may change based on the amount of movement of the spare length portion 300. FIG. 10 is an exemplary view illustrating the change in the relative position of the electrode tab 112 or 114 supported by the clip structure 250 when the swelling phenomenon occurs in the stack-type electrode assembly 110. Compared to FIG. 9, when a thickness of the stack-type electrode assembly 110 swells (thickness increases from d to d′), as the stack-type electrode assembly 110 is far away from the slit (or opening) 252 of the clip structure 250, a relative motion thereof increases. For example, when the relative position of the stack-type electrode assembly changes due to swelling by a distance D1 of about 0.1-50 mm, or preferably about 1-10 mm, the position of the top of the U-turn portion 310 may change by a distance D2 of, for example, about 0.1-20 mm, or preferably about 0.5-5 mm Thus, the spare length portion 300 may move based on an amount corresponding to a displacement of the electrode tab 112 or 114, and thereby preventing the disconnection of the electrode tab 112 or 114. In this embodiment, when a middle portion of the electrode tab 112 or 114 is supported using the clip structure 250 and movement of the electrode tab 112 or 114 due to swelling is induced into a sliding motion, the electrode tab 112 or 114 may be precisely designed to be moved only that much in proportion to a swelling level. Accordingly, the spare length portion 300 of the electrode tab 112 or 114 can effectively respond to the swelling phenomenon of the stack-type electrode assembly 110, and the position and movement of the spare length portion 300 can be precisely controlled to significantly reduce or eliminate a risk of an internal short circuit or the like.

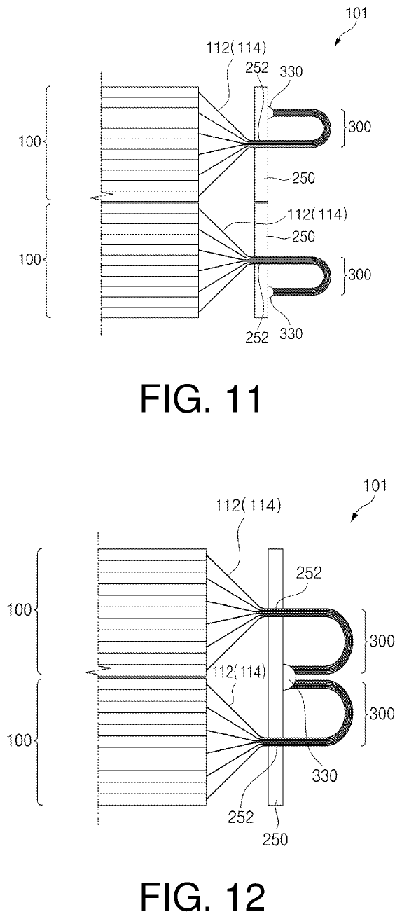

Alternatively, as shown in FIG. 11 for example, a plurality of stack-type electrode assemblies 110 may be provided in a battery cell 101. In this case, the uncoated positive and negative electrode tabs 112 and 114 extending from the plurality of stack-type electrode assemblies 110 may be inserted through the slits (or openings) 252 that are independent of each other with respect to a clip structure 250.

FIG. 11 illustrates a plurality of stack-type electrode assemblies 110 that may be supported by a plurality of clip structures 250. That is, the plurality of clip structures 250 may be provided based on the number of the plurality of stack-type electrode assemblies 110, and each stack-type electrode assembly 110 may supported by a slit (or an opening) 252 of the clip structure 250 corresponding thereto. An end portion of a spare length portion 300 provided in an electrode tab 112 or 114 extending from each stack-type electrode assembly 110 may form a welding portion 330 with respect to the clip structure 250 supporting the electrode tap 112 or 114. That is, the embodiment shown in FIG. 11 may correspond to an embodiment in which a plurality of stack-type electrode assemblies 110 may be disposed in parallel. Alternatively, an embodiment in which a plurality of stack-type electrode assemblies 110 are supported by one clip structure 250 is also possible.

Referring to FIG. 12, one clip structure 250 may include a plurality of slits (or openings) 252 corresponding to the number of stack-type electrode assemblies 110, and each stack-type electrode assembly 110 may be supported by a corresponding slit (or opening 252). An end portion of a spare length portion 300 provided in an electrode tab 112 or 114 extending from each stack-type electrode assembly 110 may form a single welding portion 330 thereof. That is, a plurality of spare length portions 300 may be welded together to form one welding portion 330. As the number of welding portions 330 decreases, having a reduced number of welding portions may improve manufacturing efficiencies.

In one embodiment, the spare length portion 300 provided in each of the electrode tabs 112 and 114 extending from the plurality of stack-type electrode assemblies 110 may form a U-turn portion 310 between the slit (or opening) 252 and the welding portion 330 as described above.

In some embodiments, a component for reducing the resistance generated when the spare length portion 300 temporarily fixed to the slit (or opening) 252 of the clip structure 250 slides may be further included. That is, the electrode tab 112 or 114 may be prevented from being damaged unintentionally due to strong resistance that may be applied when the spare length portion 300 slides. Accordingly, the clip structure 250 may include a friction reducing structure 340 on a contact surface of the slit (or opening) 252. Since the friction reducing structure 340 is provided on the contact surface of the slit (or opening) 252 pressing the electrode tab 112 or 114, the spare length portion 300 may slide smoothly.

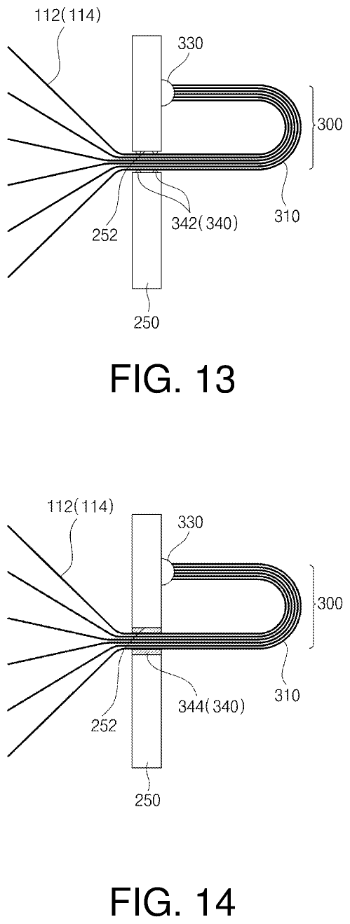

The friction reducing structure 340 provided on the slit (or opening) 252 may be implemented in various forms or types. For example, as shown in FIG. 13, an embossing structure 342 serving as the friction reducing structure 340 may be provided on the slit (or opening) 252 of the clip structure 250. The embossing structure 342, which has a hemispherical shape, reduces sliding resistance by reducing the contact area between the electrode tab 112 or 114. However, the shape of the embossing structure 342 is not limited thereto. Additionally, various other types of protrusion structures serving as the friction reducing structure 340 may be applied.

In one embodiment, as shown in FIG. 11, a low friction coating layer 344 may be used as the friction reducing structure 340. The term “low friction coating layer 344” is defined to be any type of coating layer that reduces a friction coefficient of a surface. For example, a chemically stable Teflon coating layer or a mechanically excellent diamond-like carbon (DLC) coating layer may be utilized.

While principles of this disclosure are described herein with reference to illustrative examples for particular applications, it should be understood that the present disclosure is not limited thereto. Those having ordinary skill in the art and access to the teachings provided herein will recognize additional modifications, applications, and substitution of equivalents all fall within the scope of the examples described herein. Accordingly, the present disclosure is not to be considered as limited by the foregoing description.

It will be apparent to those skilled in the art that various modifications and variations can be made to the disclosed batteries, electrode assemblies, and methods of manufacturing the batteries and electrode assemblies without departing from the scope of the disclosure. Other embodiments of the disclosure will be apparent to those skilled in the art from consideration of the specification and practice of the present disclosure disclosed herein. It is intended that the specification and examples be considered as exemplary only, with a true scope and spirit of the invention being indicated by the following claims.

What is claimed is:

1. A battery comprising:
an electrode assembly comprising:
a first electrode comprising a first portion and a first tab extending from the first portion;
a separator stacked on the first electrode;
a second electrode comprising a second portion and a second tab extending from the second portion, the second electrode being stacked on the separator; and
a current collector assembly comprising:
a plate;
a first current collector coupled to a proximal end of the plate, the first current collector including a first part and a second part opposite the first part; and
a second current collector coupled to a distal end of the plate, the second current collector including a third part and a fourth part opposite the third part; and
a housing coupled to the plate,
wherein the first tab is in a first accommodating space between the first part and the second part of the first current collector,
wherein the second tab is in a second accommodating space between the third part and the fourth part of the second current collector, and
wherein the first part and the second part of the first current collector are configured to move in opposite directions.

2. The battery according to claim 1, wherein the first portion of the first electrode comprises an active material.

3. The battery according to claim 1, wherein the first accommodating space is an opening between a proximal end of the first part and a distal end of the first part.

4. The battery according to claim 1, wherein the second accommodating space is an opening between a proximal end of the third part and a distal end of the third part.

5. The battery according to claim 1, wherein the first tab is bent toward the first part or the second part.

6. The battery according to claim 1, wherein a portion the first tab is coupled to a surface of the first current collector.

7. The battery according to claim 1, further comprising a friction reducing element between the first tab and the first part or the second part.

8. The battery according to claim 1, wherein first part and the second part apply pressure to the first tab.

9. The battery according to claim 1, wherein the plate comprises a venting portion.

10. The battery according to claim 1, wherein the plate comprises a terminal electrically coupled to the first tab or the second tab.

11. The battery according to claim 1, wherein a side of the electrode assembly is spaced apart from the first current collector or the second current collector.

12. The battery according to claim 1, wherein an end of the first tab is coupled to a coupling portion on a surface of the first part or the second part of the current collector, and
wherein the first tab forms an arc between the coupling portion and the first accommodating space.

13. The battery according to claim 12, wherein the first tab is configured to slide between the first accommodating space.

14. The battery according to claim 1, wherein the housing comprises a terminal electrically coupled to the first tab or the second tab.

15. The battery according to claim 1, wherein the housing comprises a venting portion.

16. A current collector assembly for a battery comprising:
a plate;
a first current collector coupled to a proximal end of the plate, the first current collector comprising a first part and a second part opposite the first part;
a second current collector coupled to a distal end of the plate, the second current collector including a third part and a fourth part opposite the third part;
a first accommodating space between the first part and the second part of the first current collector; and
a second accommodating space between the third part and the fourth part of the second current collector, and
wherein the first part and the second part of the first current collector are configured to move in opposite directions.

17. The current collector according to claim 16, wherein the plate comprises a venting portion.

18. A method of manufacturing a battery, the method comprising the steps of:
forming a stack-type electrode assembly by:
providing a first electrode comprising a first portion and a first tab extending from the first portion;
stacking a separator on the first electrode; and
stacking a second electrode on the separator, the second electrode comprising a second portion and a second tab extending from the second portion; and
forming a current collector assembly by:
providing a plate;
coupling a first current collector to a proximal end of the plate, the first current collector comprising a first part and a second part opposite the first part; and
coupling a second current collector to a distal end of the plate, the second current collector including a third part and a fourth part opposite the third part;
separating the first part and the second part of the first current collector in opposite directions;
inserting the first tab into a first accommodating space between the first part and the second part of the first current collector; and
inserting the second tab into a second accommodating space between the third part and the fourth part of the second current collector.

19. The method according to claim 18, further comprising bending the first tab in a first direction toward the first part or the second part.

20. The method according to claim 18, further comprising attaching an end of the first tab to a surface of the first part or the second part.
